(19) United States
(12) Patent Application Publication
(10) Pub. No.: US 2003/0225702 A1
(43) Pub. Date: Dec. 4, 2003

(54) System and method for acquisition, registration, and authentication of works of art and the like

(76) Inventors: Jorge Martin, New York, NY (US); Michael F. Melcher, New York, NY (US); Sandra J. Shepard, Petaluma, CA (US)

Correspondence Address: Hugh R. Kress, 2400 Bank One Center, 910 Travis Street, Houston, TX, 77002, US

(21) Appl. No.: 10/161,564

(22) Filed: May 31, 2002

(51) Int. Cl. G06F 17/60

(52) U.S. Cl. 705/59

(57) ABSTRACT

A system and method for acquisition, registration, and authentication of works of art and the like is provided. The system and method of the present invention changes the basis for proving legitimate possession of artwork from a bearer system based on trust of provenance provided by an art dealer (if any) to a registration system based on a license. It provides a contractual basis among the parties for assuring authenticity and exclusivity (rarity). The present invention accomplishes two important objectives: 1) it ensures that an artist produces only a designated number of copies of any single artwork, thereby establishing exclusivity, and 2) it tracks the possession of these copies, so that the authenticity and legitimacy of any particular copy can be clearly and quickly established according to agreed-upon procedures.

### FIELD OF THE INVENTION

This invention relates generally to transactions involving works of art and the like, and relates more particularly to a system and method for the acquisition, registration, and authentication of such works.

### BACKGROUND OF THE INVENTION

Art is a multi-billion dollar market. However, this market lacks, an objective, reliable, enforceable system to establish authenticity and/or exclusivity of artwork, (The term “artwork” is defined herein to comprise any form of art, originals, duplications and reproductions, including but not limited to paintings, drawings, sculptures, photographs and any objet d'art). Currently, the authenticity of artwork is subjectively, but rarely conclusively, established. There is virtually no assurance of the exclusivity of a particular piece of artwork. Exclusivity is affected not only by copies made by third parties, but also by additional copies placed on the market by the artist and/or copyright holder. Transactions and the ultimate market value of artworks are detrimentally affected by the current costs of proving authenticity and the lack of confirmed exclusivity of the artwork.

Current and prior art methods of assessing authenticity and exclusivity are particularly inadequate for art forms for which duplication is an inherent characteristic, for example: photography, lithography, silk-screening, sculptures from molds, giclée prints, and all works based on a master version that then yields numerous identical copies. For instance, it is common practice for a photographer to retain the negative; the number of copies that may be made from a single negative is virtually unlimited. The advent of digital art has significantly exacerbated this problem. Digital images can easily be reproduced in an infinite number of exact copies.

Authenticity or Provenance. Current and prior art methods and systems of assuring authenticity or provenance of an artwork are subjective. Typically, a person familiar with the oeuvre of the artist to whom the piece is ascribed provides an opinion about the authorship of the piece. The basis of the expert's knowledge may include knowledge of the artist's work style, materials, historical period, repertoire and clients, as well as articles, catalogs, or other writings that reference the piece. This method works best when the artwork is by its nature impossible to duplicate exactly (e.g., an oil painting). This method has weaknesses in any metier where the artwork is essentially a copy rather than an original (e.g., photography, where the “original” is a negative that is typically not considered the “artwork”). With these types of works, examination of the work, or an illegal copy, will not reveal a forgery. Digitizing works compounds these current problems. For example, prior to digitization, a standard photographic negative could be retired or destroyed should an artist personally desire to delimit it; then, the only means of obtaining a new “original photograph” would require reproducing a copy from the original photograph. This is more difficult, and more likely to result in inaccuracies. With digitization, however, a copier can conceivably capture a copy of a work, then, with standard and readily available software, generate an infinite number of copies identical to the original.

Another prior and current art method used for “assuring authenticity” is for the artist, or the artist's agent, to control the duplication of the work by keeping the master. For example, in the case of photography, the actual film negative can be kept in a “safe” place and only duplicated under special circumstances. This is the approach taken, for example, by Magnum Photography in New York, an entity established by photographers to manage the duplication of their images according to agreed-upon rules. However, forgery will become easier as digitization expands and the effectiveness of this method weakens.

Exclusivity. The primary current and prior art method for assuring the exclusivity of a particular duplicable work is for the artist (or copyright holder), or an agent thereof, to assert that the work is rare. This is usually accomplished through numbered series, wherein each copy is indicated with a notation of its place in a series, e.g., “8/300.” The artist typically retains the original piece, consistent with his or her retention of the copyright to the work pursuant to law and common practice. However, there is nothing that prevents an artist or the holder of the copyright for the work, such as an agent, executor or heirs, from making additional copies of the work. Image storage or safekeeping systems, such as the one employed by Magnum Photography, do not grant the collector any enforceable rights regarding the exclusivity of the work.

The market value of any artwork is in part dependent on its exclusivity. However, when numerous copies and sizes of the same artwork are possible, valuations of the artwork are complicated and difficult. At present, there is no enforceable way for a collector contemplating the acquisition of a duplicable artwork to know how many additional copies might be created in the future, or even how many already exist. Moreover, an artist currently cannot signal the intent to create a specific number of copies of a duplicable work. For example, an artist may state that only a certain number of copies will be produced (e.g., a “limited edition”); however, these limited statements are rarely enforceable against the artist or copyright holder, and generally do not prevent the artist or copyright holder from issuing later series of the work in a different size or format than the original.

The confusion and difficulty in establishing authenticity and exclusivity of artwork is economically wasteful for artists, copyright holders, and collectors. The prior and current art methods and systems of authenticating and establishing exclusivity of artworks do not efficiently provide security to promote economic value of an original and limited piece of art. Under the current method of authenticating and proving exclusivity of works of art, collectors are reduced to those who: (1) can expend resources developing an advanced base of knowledge, thus reducing the expense of evaluating the authenticity of artwork; (2) develop a personal relationship with artists; or (3) are comfortable investing in artwork in which the authenticity and exclusivity cannot be accurately determined, such that the value is indeterminate. Additionally, the current and prior art systems of authenticating and establishing the exclusivity of artwork limit the possible valuation of works for the artist or copyright holder by limiting the future resale values of such artwork.

It is desired to provide a system and method of authenticating artwork that ultimately reduces the cost of transferring the artwork and promotes its value. It is further desired to confirm and assure exclusivity of an artwork and thus potentially increase its value.

### SUMMARY OF THE INVENTION

In view of the foregoing and other considerations, the present invention relates to a system and method of authenticating and establishing exclusivity of artworks to increase confidence and accuracy in their valuation and reduce the time and costs associated with their transfer.

It is a feature of the present invention to provide a system and method for authenticating artwork and providing a chain of possession to ensure the authenticity of such work according to agreed-upon procedures.

It is a further feature of the present invention to provide a system and method for maintaining the exclusivity of artwork by providing information to collectors concerning the artwork's exclusivity.

It is a still further feature of the present invention to provide a system and method to provide a central registry to maintain records related to artwork.

The system and method of the present invention changes the basis for proving legitimate possession of artwork from a bearer system based on trust of provenance provided by an art dealer (if any) to a registration system based on a license. It provides a contractual basis among the parties for assuring authenticity and exclusivity (rarity). The present invention accomplishes two important objectives: 1) it ensures that an artist produces only a designated number of copies of any single artwork, thereby establishing exclusivity, and 2) it tracks the possession of these copies, so that the authenticity and legitimacy of any particular copy can be clearly and quickly established according to agreed-upon procedures.

The present invention includes an assignable artwork transfer license and an artwork registry. The license is a contract governing the transfer of an artwork from an artist or copyright holder to a collector, and from that collector to a subsequent collector, and so on. The system and method of the present invention replaces the current cash-and-carry purchase transaction for artwork acquisitions. As a perpetual, exclusive, transferable, worldwide license, the license transfers most of the beneficial rights of ownership in the artwork; however, it contains some important restrictions that act to ensure the authenticity and exclusivity of the work according to agreed-upon procedures. First, the license requires the artist to stipulate by contract the maximum number of copies, including, for example, artist's proofs, work prints and studies that will ever be made of the particular artwork. The license may include limited exclusions allowing particular types of reproductions by the artist for specific enumerated purposes, where such reproductions will not adversely affect the market value of the work. Second, the license requires that any transfer of the artwork be recorded in a register at the registry and be maintained by an agent designated by, and on behalf of, the registry. Each proper transfer of the artwork and assignment of license may be evidenced by a certificate issued to the transferee (generally referred to as “collector”) by the registry upon proper registration.

Any work transferred to a subsequent collector without such recordation within a designated period of time is deemed to have violated the license; possession of the artwork by such subsequent collector is therefore deemed to be inauthentic. Pursuant to the present invention, if the artist or copyright holder makes an unauthorized copy of the work, or if another person creates a forgery, there will be no corresponding entry in the registry and the copy will be deemed inauthentic.

Although not described in detail, it should be recognized that the system and method of the present invention may utilize electronic systems for transmitting, filing and storing various documents and data related to the system and method.

The system and method of the present invention will increase the value of artworks by eliminating much of the uncertainty involved in evaluating their authenticity and exclusivity—both for artwork in general and for duplicable, or “editioned”, artwork in particular. The present invention makes the value of art more transparent by employing a warranty governing the number of copies of a particular work that the artist or copyright holder can ever create. The present invention makes the assessment of artistic provenance more objective by using the registry to track the status, according to agreed-upon procedures, of all legitimate pieces. The present invention also makes artists' assurances of authenticity and exclusivity enforceable, removing these factors from the realm of guesswork by memorializing them in written, legally enforceable agreements. The present invention creates an efficient new system for trading artwork by reducing the transaction costs of acquiring and de-accessioning such works which, in turn, opens the art market to new collectors who will, in all likelihood, increase the total amount of spending on art and ultimately increase artists' incomes.

The foregoing has outlined rather broadly the features and advantages of the present invention in order that the detailed description of the invention that follows may be better understood. Various combinations of features may be utilized singularly or in combination to achieve the invention as taught. Additional features and advantages to the invention will be described hereinafter which form the subject of the claims appended hereto.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is an illustration of the system and method of the present invention.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and programming decisions must be made to achieve the developers' specific goals and subgoals (e.g., compliance with system and technical constraints), which will vary from one implementation to another. Moreover, attention will necessarily be paid to proper practices for the environment in question. It will be appreciated that such a development effort might be complex and time-consuming, but would nevertheless be a routine undertaking for those of ordinary skill in the relevant fields.

Furthermore, for the purposes of the present disclosure, the terms “comprise” and “comprising” shall be interpreted in an inclusive, non-limiting sense, recognizing that an element or method step said to “comprise” one or more specific components may include additional components.

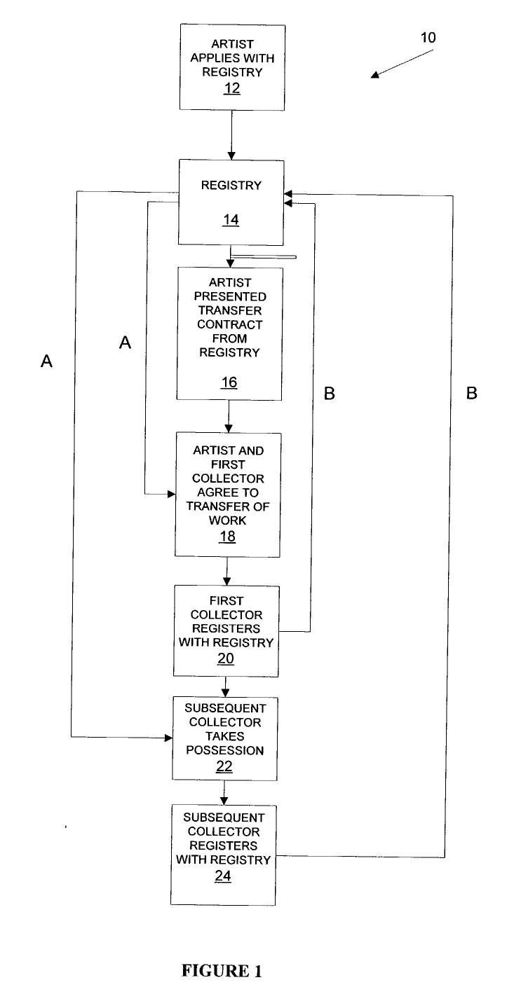

FIG. 1 is an illustration of the system and method for acquisition, registration, and authentication of artworks of the present invention generally designated by the numeral 10. The system and method of the present invention includes an artist or copyright holder of an artwork, a registry, and at least one consumer or collector.

Registry 14 is an entity that is established to maintain and implement the standards for the present invention to ensure that consistency and effectiveness among multiple artworks, artists, collectors and other individuals or entities are maintained. Registry 14 also manages the database of all documents confirming the authentication of artworks, the exclusivity of artworks and the chain of possession of artworks for authentication, in each case according to agreedupon procedures. Registry 14, as an entity, may be authorized to enforce contracts as related to the authentication, exclusivity and/or registration of artworks.

The system and method of the present invention is further described with reference to FIG. 1. In step 12, an artist or other entity or individual that has exclusive ownership rights and control of subsequent duplications of the artwork applies to registry 14 for registration. For brevity, “artist” is used herein to represent any person or entity that may originally register an artwork. The artist applies for registration of a particular work with registry 14 by completing a standard application provided by registry 14. Information required on the standard application may include a description of the work, a photograph or like representation of the work, information relating to the authenticity and rights of ownership in the work, and information related to the exclusivity of the work. The exclusivity information will include the number of copies, including, for example, artist's proofs, work prints and studies, that will ever be produced and, among other information, the sizes of the copies to be made of the work. The artist is also required to agree to a license of the work that is described further below. Typically, a fee will also be paid to registry 14 for registering the artwork.

Registry 14 will review the registration application to ensure that all agreed-upon procedures concerning the authenticity and exclusivity of the work have been followed, and that the artist has agreed to comply with the license agreement. Upon approval, the application for the work will be filed with, and maintained by, registry 14. Additionally, a legally binding transfer contract, including a license, will be prepared based on the information provided in the registration application. The artist will be presented with the transfer contract and license in step 16. The artist may further be presented with a certificate of registration.

The transfer contract will include: (1) standard “invoice” terms (e.g., a price which may be filled in at the time of a subsequent sale of the work, the number of the works in the edition, and a description of the work); and (2) the license. In addition, a form of a subsequent transfer agreement will be provided should the collector choose to transfer the artwork to another party. The transfer contract may require that notice of the license be placed proximate the artwork. Proximate to the artwork includes requiring that the license terms be affixed physically to the work or, upon approval by registry 14, being incorporated by reference by express notation thereof on or near the artwork, so that collectors take the work with notice of the license terms. “Collector” as used herein includes any transferees.

The license terms govern the transfer of an artwork from an artist to a collector, and from that collector to a subsequent collector, and so on. The license may contain terms for the enforcement by registry 14 of registration and reproduction limits. As a perpetual, exclusive, transferable, worldwide license, the license transfers most of the beneficial rights of ownership in the work and it contains restrictions that act to ensure the authenticity and exclusivity of the work according to agreed-upon procedures. The license requires the artist to stipulate by contract the maximum number of copies of the artwork including, for example, artist's proofs, work prints and studies that will ever be made. The license may contain limited exclusions allowing particular types of reproductions by the artist for specific enumerated purposes. These exclusions may include, by example, reproductions that would not adversely affect the market value of the work (e.g., reproductions used for informational, copyright, publicity, biographical or marketing purposes, including but not limited to, digital thumbnails, postcard images, and images in journals and publications). Further the license requires that any transfer of the work be recorded with registry 14. The license may provide that if any of the parties to the agreement (i.e., the artist or copyright holder, the collector, or any subsequent collector), fails to comply with the obligations under the agreement, including the requirement to register any transfer and assignment, the other party(ies) and registry 14 may have the right to sue for relief according to the terms of the contract.

In step 18 an artist agrees with a collector to transfer the artwork. The collector may contact registry 14, indicated by line “A”, to receive confirmation of the authenticity of the documents and agreements presented by the artist. Upon completion of the transfer contract and license, the collector will have a set period of time to file the contract and license with registry 14.

In step 20, the collector forwards the signed contract and a registration fee to registry 14 as indicated by line “B”. In consideration of the registration fee, registry 14 will maintain a record for the artwork. For subsequent transfers, steps 22 and 24, registry 14 forwards the collector a new form of subsequent transfer agreement that must be used to transfer the artwork and assign the license to the next collector. The form of the subsequent transfer contract is essentially identical to the original transfer contract, except that the parties are now collector and subsequent collector rather than artist and collector.

From the foregoing detailed description of specific embodiments of the invention, it should be apparent that a system and method for the acquisition, registration, and authentication of works of art has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims, which follow.

What is claimed is:

1. A method of registration and authentication of an artwork; said method comprising the steps of:
establishing a registry for maintaining documents identifying artworks and their provenance, maximum limits as to copies of each said artwork to be produced, and a chain of possession for each said artwork;
filing an application for registration of a said artwork with said registry by an artist, said application comprising proof of provenance of said artwork, proof of exclusive control of duplication rights in said artwork, legally binding maximum limits of copies of said artwork to be produced, and agreement by said artist to be bound by said maximum duplication limits;
registering said artwork with said registry, said registration comprising maintaining information as to said provenance of said artwork, said possession of said registered artwork, and said maximum limits of said copies of said artwork to be produced;
providing said artist with a binding transfer contract for transferring possession of said registered artwork to a collector, said transfer contract including a license from said artist to said collector and subsequent collectors binding said artist to a maximum copy limit of said artwork, and said transfer contract requiring that any said collector receiving said registered artwork to register said artwork with said registry;
recording each said collector in said registry as holder of a said artwork upon receipt of a completed said transfer contract indicating a complete chain of possession for said artwork; and
maintaining said documents by said registry to establish a chain of possession and exclusivity for each said registered artwork for confirming said artwork is authentic, upon acquisition of said artwork by a said collector.

2. The method of claim 1, further including the step of:
placing notice of said license proximate said artwork.

3. The method of claim 1 wherein said license includes exclusions from said maximum limits for producing reproductions for marketing purposes.

4. The method of claim 1 wherein said license includes exclusions from said maximum limits for producing reproductions for biographical purposes.

5. The method of claim 1 wherein said license includes exclusions from said maximum limits for producing reproductions for informational purposes.

6. The method of claim 1 wherein said license includes exclusions from said maximum limits for producing reproductions for biographical and marketing purposes.

7. The method of claim 1 wherein said license includes exclusions from said maximum limits for producing reproductions for biographical and informational purposes.

8. The method of claim 1 wherein said license includes exclusions from said maximum limits for producing reproductions for informational and marketing purposes.

9. A method of registration and authentication of an artwork; said method comprising the steps of:
establishing a registry for maintaining documents identifying artworks and their provenance, maximum limits as to copies of each said artwork to be produced, and a chain of possession for each said artwork;
filing an application for registration of a said artwork with said registry by an artist, said application comprising proof of provenance of said artwork, proof of exclusive control of duplication rights in said artwork, legally binding maximum limits of copies of said artwork to be produced, and agreement by said artist to be bound by said maximum duplication limits;
registering said artwork with said registry, said registration comprising maintaining information as to said provenance of said artwork, said possession of said registered artwork, and said maximum limits of said copies of said artwork to be produced;
providing said artist with a binding transfer contract for transferring possession of said registered artwork to a collector, said transfer contract including a license from said artist to said collector and subsequent collectors binding said artist to a maximum copy limit of said artwork, and said transfer contract requiring that any said collector receiving said registered artwork to register said artwork with said registry;
placing notice of said license proximate said artwork;
recording each said collector in said registry as holder of a said artwork upon receipt of a completed said transfer contract indicating a complete chain of possession for said artwork; and
maintaining said documents by said registry to establish a chain of possession and exclusivity for each said registered artwork for confirming said artwork is authentic, upon acquisition of said artwork by a said collector.

10. The method of claim 9 wherein said license includes exclusions from said maximum limits for producing reproductions for marketing purposes.

11. The method of claim 9 wherein said license includes exclusions from said maximum limits for producing reproductions for biographical purposes.

12. The method of claim 9 wherein said license includes exclusions from said maximum limits for producing reproductions for informational purposes.

13. The method of claim 9 wherein said license includes exclusions from said maximum limits for producing reproductions for biographical and marketing purposes.

14. The method of claim 9 wherein said license includes exclusions from said maximum limits for producing reproductions for biographical and informational purposes.

15. The method of claim 9 wherein said license includes exclusions from said maximum limits for producing reproductions for informational and marketing purposes.

16. A method of registration and authentication of an artwork; said method comprising the steps of:
establishing a registry for maintaining documents identifying artworks and their provenance, maximum limits as to copies of each said artwork to be produced, and a chain of possession for each said artwork;
filing an application for registration of a said artwork with said registry by an artist, said application comprising proof of provenance of said artwork, proof of exclusive control of duplication rights in said artwork, legally binding maximum limits of copies of said artwork to be produced, and agreement by said artist to be bound by said maximum duplication limits;
registering said artwork with said registry, said registration comprising maintaining information as to said provenance of said artwork, said possession of said registered artwork, and said maximum limits of said copies of said artwork to be produced;
providing said artist with a binding transfer contract for transferring possession of said registered artwork to a collector, said transfer contract including a license from said artist to said collector and subsequent collectors binding said artist to a maximum copy limit of said artwork excluding reproductions, and said transfer contract requiring that any said collector receiving said registered artwork to register said artwork with said registry;
placing notice of said license proximate said artwork;
recording each said collector in said registry as holder of a said artwork upon receipt of a completed said transfer contract indicating a complete chain of possession for said artwork; and
maintaining said documents by said registry to establish a chain of possession and exclusivity for each said registered artwork for confirming said artwork is authentic, upon acquisition of said artwork by a said collector.
